(19) United States
(12) Patent Application Publication
(10) Pub. No.: US 2003/0101275 A1
(43) Pub. Date: May 29, 2003

(54) Information processing system accessed through network and control method of packet transfer load

(76) Inventor: Frederico Buchholz Maciel, Kokubunji (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/084,474

(22) Filed: Feb. 28, 2002

(30) Foreign Application Priority Data
Nov. 28, 2001 (JP) 2001-361913

(51) Int. Cl. G06F 15/173

(52) U.S. Cl. 709/235; 709/239; 709/249

(57) ABSTRACT

An information processing system having a plurality of address translators between an external network and an internal network to which a plurality of servers are connected, and a controller for switching an access route to a specific server from a route of a first address translator to a route of a second address translator. The controller instructs the second address translator to store received packets destined for the specific server, instructs the first and second address translators to switch a control parameter so that packets for the specific server are received by the second address translator in place of the first address translator, and shifts a control information entry to be used for address translation of packets destined to the specific server from the first address translator to the second address translator. After that, the second address translator translates the address of stored packets and new packets in accordance with the control information entry to transfer the packets to the internal network.

### BACKGROUND OF THE INVENTION

(1) Field of the Invention

The present invention relates to an information processing system connected to a plurality of load balancers or network address translators and, more particularly, to a technique of changing a server access route for distribution or failover of communication loads in a plurality of network address translators or load balancers disposed between the Internet and a Web site constructed by a plurality of servers.

(2) Description of the Related Art

At present, due to a rapid increase in a communication amount in the Internet, it becomes difficult in each Web site to process a number of accesses from clients by a single Web server. Consequently, one Web site is constructed by a plurality of Web servers. Various methods for properly distributing accesses from clients to the plurality of servers constructing a Web site have been proposed and, in recent years, an apparatus called a load balancer is used increasingly.

FIG. 1 shows an example of using load balancers in a conventional technique.

Clients 1a to 1c access a Web site via the Internet 2. The Web site is constructed by a load balancer 3a disposed between the Internet 2 and an internal network 4, and a plurality of servers 5a to 5c each executing a Web server program. Accesses to the Web site are accepted by the load balancer 3a in place of the servers, and the load balancer 3a distributes the accesses to the plurality of servers 5a to 5c via the internal network 4.

In this case, the load balancer 3a transparently translates a network address of each packet for communication between the clients 1a to 1c and the servers 5a to 5c with reference to an access correspondence table 9a which will be described hereinlater to thereby realize the load balancing function. A basic method of address translation applicable to the load balancer 3 is described in, for example, “The IP Network Address Translator (NAT)”, Internet Engineering Task Force RFC1631 (hereinbelow, called Literature 1).

Address translation executed by the load balancer 3a will now be described. In the specification, each of IP addresses assigned to network interfaces of various communication apparatuses is expressed by adding characters “IP” to the reference numeral/character (for example, 10a to 10c, 31a, 32a, and 51a to 51c in FIG. 1) of each interface. When one interface has a plurality of IP addresses, each address is specified in the form where an ordinal is added to the characters “IP”.

As shown in FIG. 1, in the case where the single load balancer 3a is used for a Web site, when the number of accesses increases, there is the possibility that the load balancer 3a becomes a bottleneck. In the case where the load balancer 3a fails, accesses to the whole Web site from the clients 1a to 1c become impossible.

Consequently, as the number of accesses to the Web site increases, the availability of the single load balancer 3a for the Web site decreases. As shown in FIG. 2, the configuration of a site using a plurality of load balancers 3a and 3b in parallel is desirable.

A system using a plurality of load balancers in parallel has two operation modes; an active/standby mode, and an active/active mode as described in, for example, “WWW server load balancer with functions being enhanced”, Nikkei Open System, November, 1999, ISSN 0918-581X, pp 128-131, hereinbelow called Literature 2.

In the active/standby mode, one load balancer, for example, 3a becomes active and the rest, for example, 3b becomes standby. Consequently, although a plurality of load balancers are used for a Web site, the packet transfer ability cannot exceed that of one load balancer. In contrast, in the active/active mode, since all of load balancers simultaneously operate, the efficiency of relaying accesses to the Web server is high.

### SUMMARY OF THE INVENTION

However, the conventional active/active mode has the following three problems.

A first problem is that, as also pointed out in Literature 2, the packet transfer load onto a Web site cannot be dynamically distributed to a plurality of load balancers at any time. Specifically, a client usually accesses the Web site by fixedly designating a load balancer as a connection destination, so that a communication load to a Web site cannot be dynamically distributed to a plurality of load balancers.

A second problem is that when any one of load balancers fails and failover is tried to be implemented by handing the Web access passing through the failed load balancer over to another load balancer, in many cases, access control information of the failed load balancer is lost. Consequently, the access to the Web site is interrupted.

A third problem is that, although connection dedicated to load balancers and a function of always copying an access correspondence table to which each of load balancers refers to another load balancer are used as necessary for security, when the number of load balancers constructing a Web site becomes large, the functions regulate the scalability of the Web site.

These three problems are not problems which occur only in a load balancer or network address translator (NAT) applied to the Web site but commonly occur also in the case where a plurality of communication apparatuses such as network adapters or gateways are operated in parallel in the active/active mode.

An object of the invention is to realize dynamic distribution of communication loads in a network system in which a plurality of packet transfer apparatuses such as network address translators, network adapters, or gateways typified by the above-described load balancers are connected in parallel and operated in the active/active mode.

Another object of the invention is to provide a network system and an information processing system which can implement failover of dynamically changing an access route (communication path) to a server or information processor among a plurality of communication packet transfer apparatuses without interrupting an access from clients.

Further another object of the invention is to provide a network system and an information processing system with improved scalability, in which the number of packet transfer apparatuses used in the active/active mode can be easily increased or decreased.

Further another object of the invention is to provide a control method for changing the packet transfer loads of a plurality of communication packet transfer apparatuses without interrupting packet flows.

An information processing system according to a typified embodiment of the invention includes a plurality of information processors connected to an internal network, and a plurality of address translators or load balancers for translating a destination address of a packet received from the external network to an address of an information processor to be accessed and transferring the address-translated packet to the internal network.

In the case of changing an access route to a specific information processor from a first route passing through a first address translator to a second route passing through a second address translator, packet receiving control parameters which are set in the first and second address translators is changed so that packets to be transferred to the specific information processor are received by the second address translator in place of the first address translator. After that, a control information entry necessary for translating the address of the packets to be transferred to the specific information controller and response to an access is shifted from a first access correspondence table referred to by the first address translator to a second access correspondence table referred to by the second address translator.

When the second address translator receives packets to be transferred to the specific information processor before the control information entry necessary for the address translation is added to the second access correspondence table, received packets are discarded in the prior art.

In the invention, therefore, in order to avoid discarding of the received packets in the second address translator after changing the packet receiving control parameter, the operation mode of the second address translator is set to a transition mode of temporarily storing the received packets to be transferred to the specific information processor into a memory. After completion of the shifting of the control information entry, the operation mode of the second address translator is returned from the transition mode to a normal mode, that is, a mode of transferring received packets in accordance with a control information entry registered in an access correspondence table.

The control of changing the access route is executed by, for example, an instruction from a controller connected to the internal network. The function of the controller may be provided for one of the plurality of information processors each for executing an information processing operation in response to a packet received from a client.

According to the invention, when the mode is returned from the transition mode to the normal mode, the second address translator processes the packets stored in the memory in accordance with a new control information entry added to the access correspondence table, thereby enabling the access route to be switched without interrupting the communication due to discarding of the packets.

To realize failover among address translators, according to the invention, the contents of the access correspondence table referred to by each address translator are stored as a copy into a device different from the address translators. With the configuration, for example, when the first address translator fails and a packet flow transferred by the first address translator has to be processed by the second translator, the control information entry newly required by the second address translator can be supplied from the copy stored in the another device.

For example, according to the contents of the control information entry of each access correspondence table, copies of the access correspondence table are distributed to and stored in the plurality of information processors connected to the internal network.

A communication system such as a network address translator or load balancer according to the invention is characterized by having an operation mode (transition mode) for controlling the function of receiving a packet flow and the transferring the function by a control message supplied from the outside and, when a function of receiving a new packet flow is added, until a function of transferring the packet flow becomes ready, temporarily storing the received packet belonging to the new packet flow.

### BRIEF DESCRIPTION OF THE DRAWINGS

FIG. 1 is a block diagram showing a network configuration of a conventional technique using one load balancer for a Web site.

FIG. 2 is a block diagram showing a network configuration of a conventional technique using a plurality of load balancers for a Web site.

FIG. 3 is a block diagram showing a network configuration according to a first embodiment of the invention.

FIGS. 4A and 4B are diagrams showing packet formats before and after address translation for explaining translation of a packet address in a first embodiment of the invention.

FIG. 5 is a diagram showing the contents of an access correspondence table of a load balancer 3a illustrated in FIG. 3 before an access route is changed.

FIG. 6 is a diagram showing the contents of an access correspondence table of a load balancer 3b illustrated in FIG. 3 before an access route is changed.

FIGS. 7A and 7B are diagrams showing transfer processing mode tables of the load balancers 3a and 3b before the access routes are changed.

FIGS. 8A to 8C are diagrams for explaining the change in the state of transfer processing mode tables in a process of changing an access route.

FIG. 9 is a diagram showing the contents of an access correspondence table of the load balancer 3b after the access route is changed.

FIG. 10 is a diagram showing the contents of an access correspondence table of the load balancer 3a after the access route is changed.

FIGS. 11A and 11B are diagrams showing packet formats before and after address translation for explaining address translation in a second embodiment of the invention.

FIG. 12 is a diagram showing an access correspondence table used for address translation in the second embodiment of the invention.

FIG. 13 is a block diagram showing the configuration of a Web site in a third embodiment of the invention for realizing failover.

FIG. 14 is a diagram showing a TCP/IP connection table of an operating system.

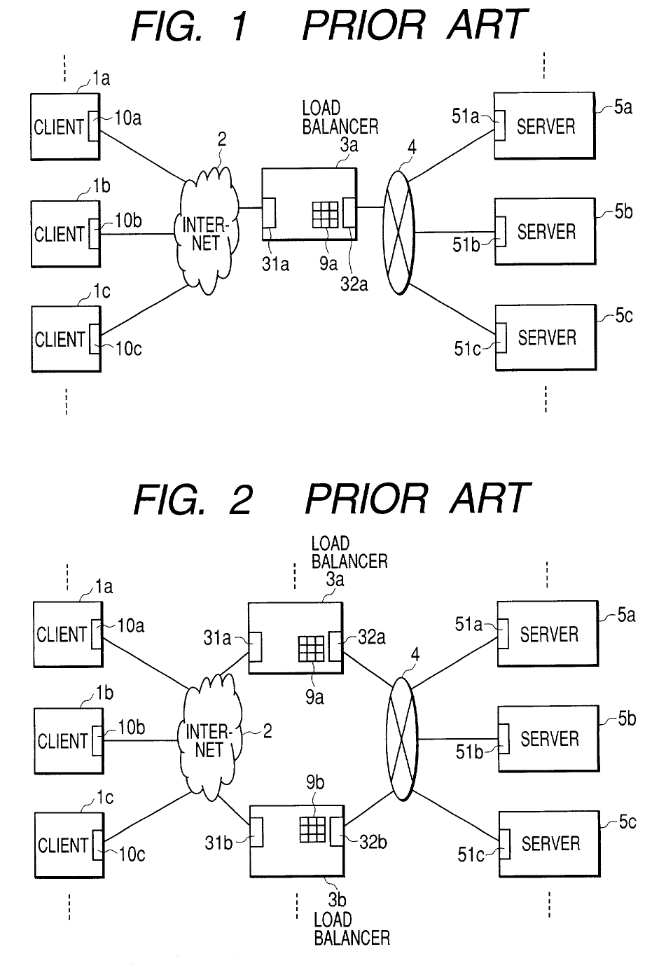

### DESCRITPION OF THE PREFERRED EMBODIMENTS

1. First Embodiment of the Invention

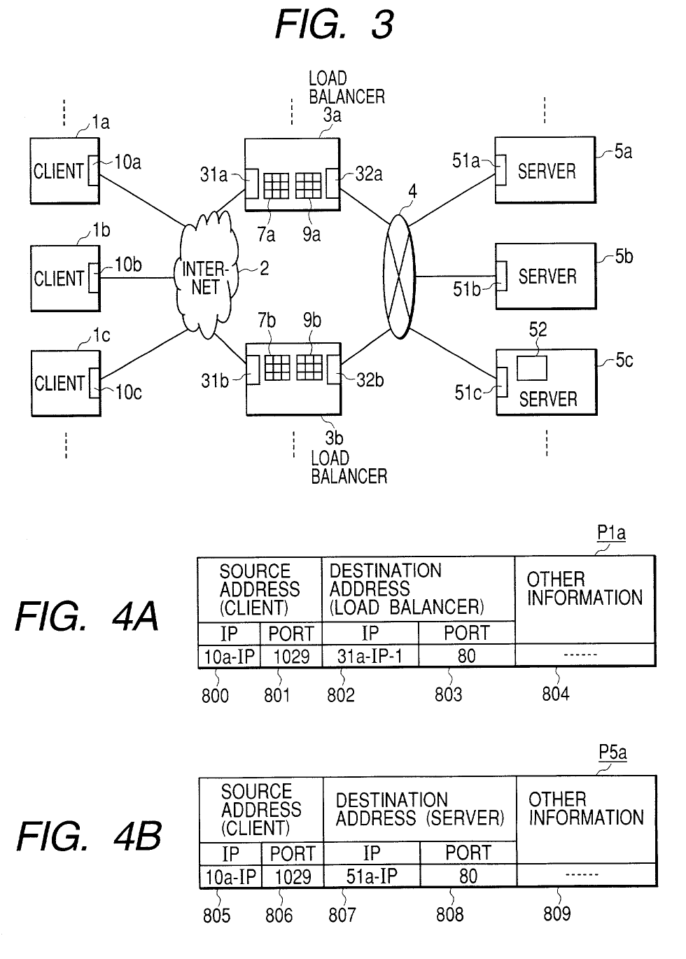

FIG. 3 shows a network configuration including an information processing system according to a first embodiment of the invention.

In the embodiment, an information processing system realizing a Web site of the Internet is constructed by a plurality of Web servers 5a, 5b, and 5c and a plurality of load balancers 3a and 3b mutually connected via an internal network 4.

Although the Web site usually has components other than the load balancers 3a and 3b, network 4, and servers 5a to 5c, only main components related to the invention are shown in order to simplify the drawing. In the following embodiment, an example of applying the invention to a Web site will be described. However, the use of the load balancers 3a and 3b is not limited to an access to a Web site, but the load balancers 3a and 3b can be also used for other Internet service sites such as FTP and electronic mail. The servers 5a to 5c shown in FIG. 3 therefore may provide information services other than Web.

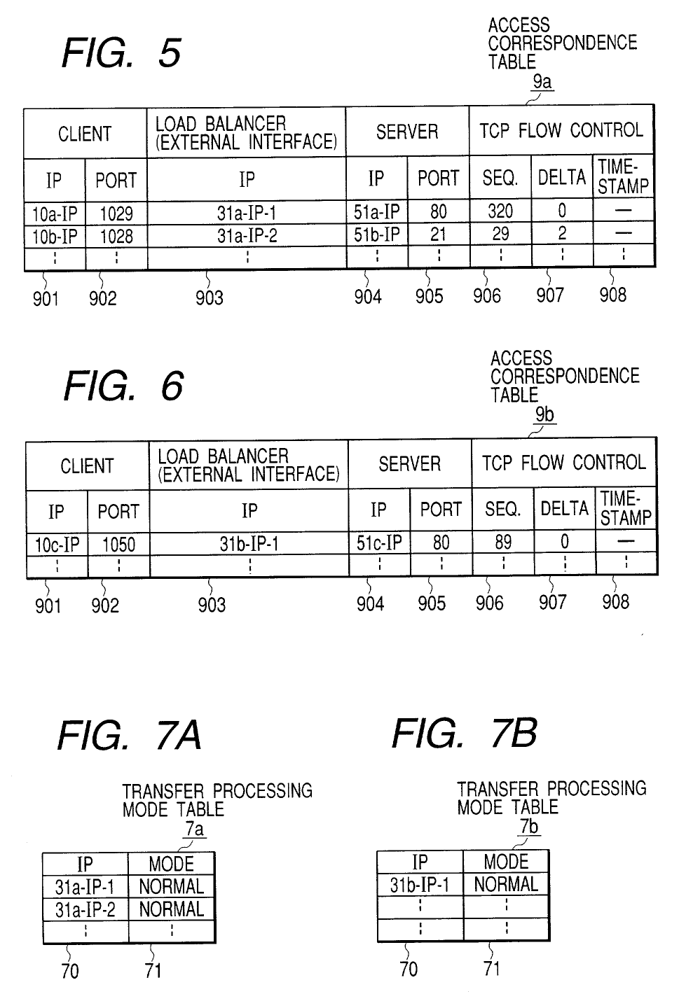

Before explaining transition of a load of packet transfer among load balancers as a feature of the embodiment, referring to FIGS. 4A, 4B, and 5, address translation of a received packet performed by load balancers will be described.

FIG. 4A shows the format of a communication packet (IP packet) P1a transmitted between a client 1a and the load balancer 3a shown in FIG. 3, and FIG. 4B shows the format of a communication packet P5a transmitted between the load balancer 3a and the server 5a. Each of the communication packets has a source IP address 800 (805) and a source port number 801 (806) as a source address, a destination IP address 802 (807) and a destination port number 803 (808) as a destination address, and other information 804 (809). Only some items related to the invention in header information of an IP packet are shown here.

When the packet P1a shown in FIG. 4A is received from the client 1a, the load balancer 3a specifies a Web access from the source address (800, 801) and the destination address (802, 803). After that, the load balancer 3a changes the destination IP address 802 of the received packet to an IP address “51a-IP” of a server (server 5a in the example) which is supposed to process the Web access as shown in the destination IP address 807 in FIG. 4B, and transmits the resultant as the packet P5a to the network 4. Since the destination address 807 of the received packet P5a indicates the address of the server 5a, the server 5a accepts the packet and executes an information process according to the contents of the received packet.

In a packet communication in the direction opposite to the direction from a server to a client, the server 5a uses the load balancer 3a as a router to the Internet 2. A packet returned from the server 5a to the client 1a is received by the load balancer 3a. The source address and the destination address in the header of the returned packet are the inverse of those of the packet P5a shown in FIG. 4B. Before the return packet is transferred to the client 1a via the Internet 2, the load balancer 3a performs address translation inverse to the translation from the packet P1a to the packet P5a and rewrites the source IP address from “51a-IP” to “31a-IP1”.

In order to perform the address translation, the load balancer 3a uses, for example, an access correspondence table 9a shown in FIG. 5.

The access correspondence table 9a comprises of a plurality of lines, and each line corresponds to one entry in which access control information is stored. Each access control information entry includes an IP address 901 and a port number 902 of a client, an IP address 903 assigned to an external interface 31a of a load balancer, an IP address 904 and a port number 905 of a server to be accessed, and TCP flow control information 906 to 908. As the TCP flow control information is described in detail in Literature 1, it is not described in this specification.

When the packet P1a is received from the client 1a, the load balancer 3a specifies an access control information entry corresponding to the received packet by collating the address information 800 to 803 with the information items 901, 902, 903, and 905 in the access correspondence table 9a.

By using the server IP address 904 indicated in the specified access control information entry, the destination IP address of the received packet is translated, and the packet P5a shown in FIG. 4B is generated.

The load balancer 3a similarly performs address translation of a communication packet in the opposite direction transmitted from the server to the client. When the load balancer 3a receives a packet for which corresponding access control information is not yet registered in the access correspondence table 9a and the received packet is a control packet for connection settlement request to start the Web access, the load balancer 3a adds a new access control information entry for the Web access to the access correspondence table 9.

If the received packet is not the control packet for connection settlement request, the load balancer 3a returns an error message to one of the clients 1a to 1c and servers 5a to 5c which is the source of the received packet. After completion of the Web access, the load balancer 3a deletes the corresponding access control information entry from the access correspondence table 9a.

The communication load distribution and failover among load balancers are realized by two steps, specifically, a computing step of communication load assignment and a communication load changing step.

In the communicating step of communication load assignment, optimum combination of communication loads and load balancers is computed to optimally distribute the communication load. By assigning no communication load to a failed load balancer, failover can be realized.

On the other hand, in the communication load changing step, by actually shifting a communication load (Web access route) among the load balancers, the preferred communication load distribution computed in the computing step of the communication load assignment is realized.

The calculation of the communication load assignment is specifically introduced in, for example, “Dynamic Gateways: A Novel Approach to Improve Networking Performance and Availability on Parallel Servers”, Proceedings of the HPCN '98, pp 678-687, Springer-Verlag, 1998, ISSN 0302-9743 (hereinbelow, called Literature 3) and U.S. Pat. No. 6,112,248.

With respect to the transition of a communication load among load balancers, problems of the conventional technique will be described first.

For example, in the case of changing the access route from the client 1a to the Web server 5a from a first route passing through the load balancer 3a to a second route passing through the load balancer 3b, switching of the communication route and switching the access control information to be registered in the access correspondence table from the load balancer 3a to the load balancer 3b are necessary.

In this case, in the two switching operations, a which-came-first-the-chicken-or-the-egg question arises. For example, if the access control information is rewritten after switching the packet communication route, during the two switching operations, the load balancer 3b receives a communication packet for which the access control information is not yet registered in the access correspondence table 9b shown in FIG. 6 to be referred by the load balancer 3b.

In this case, the address of the received packet cannot be translated, a problem such that the received packet is discarded and an error message is returned to the packet source occurs. On the contrary, in the case where the access control information is moved from the access correspondence table 9a to the access correspondence table 9b and after that the communication path is switched, when the load balancer 3a receives a packet during the two switching operations, a problem such that the access control information necessary for the address translation and packet transfer has already been absent occurs.

The switching of the Web access route between the load balancers according to the invention will be described hereinbelow. It is assumed that the access correspondence table 9a of the load balancer 3a and the access correspondence table 9b of the load balancer 3b before shifting the Web access route have the contents as shown in FIGS. 5 and 6, respectively.

As an embodiment of the invention, a procedure taken in the case of switching the route of an access from the client 1a to the server 5a from the first route passing through the load balancer 3a to the second route passing through the load balancer 3b will be described. First, the outline of the procedure of changing the access route (communication route) according to the embodiment will be described.

The access route is changed on the unit basis of an IP address assigned to a connection interface (external interface) to an external network (Internet 2) of each load balancer. For example, therefore, in the load balancer 3a, an IP address “31a-IP-1” or “31a-IP-2” of the external interface 31a is a unit of changing the access route. In the load balancer 3b, an IP address “31b-IP-1” of the external interface 31b is a unit of changing the access route.

In the embodiment, each of servers forming a Web site is associated with the IP address of an external interface of the load balancer 3a or 3b. In the example, the servers 5a, 5b, and 5c belong to the IP addresses “31a-IP-1”, “31a-IP-2”, and “31b-IP-1”, respectively. In this case, the destination IP address of each of packets transferred from the clients 1a, 1b, and 1c via the Internet 2 to the Web site indicates, for example, the IP address of an external interface of any of the load balancers as shown in FIG. 4A.

Each load balancer selectively receives a packet whose destination IP address coincides with an IP address assigned to the external interface of itself from the Internet 2. When the Web access packet is received, each load balancer rewrites the destination IP address of the received packet to a server IP address belonging to the IP address of the external interface, and transfers the resultant as the received packet P5a shown in FIG. 4B to the internal network 4 on the server side.

Therefore, by shifting the destination of assignment of the IP address of an external interface, for example, “31a-IP-1” from the external interface 31a of the load balancer 3a to an external interface 31b of the load balancer 3b, the access route to a server belonging to the IP address “31a-IP-1” can be changed from the first route passing through the load balancer 3a to the second route passing through the load balancer 3b.

If an IP address is assigned dynamically to an external interface as described above, IP addresses of the number larger than the number of load balancers are required. To distribute a communication load among IP addresses, for example, the technique of round-robin DNS (described by Eric Dean Katz, Michelle Butler, and Robert McGrath, in “A Scalable HTTP Server: The NCSA Prototype”, Proceedings of the First International Conference on the World-Wide Web, 1994) can be used.

In the embodiment, as shown in FIG. 3, one of a plurality of servers constructing the Web site, for example, the control server 5c has a control function 52 for managing the IP addresses assigned to the load balancers, collecting information of a communication amount of each of load balancers necessary to distribute the communication load among the load balancers, computing assignment of the load, and instructing a shift of the Web access relay route by moving the IP address. When the assignment of optimum IP addresses to load balancers is found as a result of the computation of the load assignment by the control function 52, as a result, the IP address to be shifted by changing the assignment of the load is known.

The feature of the embodiment is how to realize switching of the access route (communication route) by shifting the IP addresses among the load balancers. A case of changing the assignment of the IP address “31a-IP-1” from the load balancer 3a to the load balancer 3b will be described.

As shown in FIGS. 5 and 6, it is assumed that the IP addresses “31a-IP-1” and “31a-IP-2” of the external interfaces are registered in the access correspondence table 9a of the load balancer 3a, and the IP address “31b-IP-1” of the external interface is registered in the access correspondence table 9a of the load balancer 3b at present.

In the case where the computation for assigning the load is executed by the control function 52 and it is determined that the IP address “31a-IP-2” is to be assigned to the load balancer 3a and the IP addresses “31a-IP-1” and “31b-IP-1” are to be assigned to the load balancer 3b, the access control information entry including the IP address “31a-IP-1” registered in the access correspondence table 9a shown in FIG. 5 has to be moved to the access correspondence table 9b of the load balancer 3b.

In the embodiment, the IP address is moved through a process comprising the following four steps.

In the first step, a control message notifying of transition of the IP address “31a-IP-1” is transmitted from the control server 5c (control function 52) to the load balancer 3b. The load balancer 3b having received the notification sets a mode (hereinafter, called a transition mode) different from a normal operation mode as a transfer processing mode of a received packet which has the IP address “31a-IP-1” as a destination address. The transition mode is a control mode peculiar to the invention.

When a packet having an IP address designated in the transition mode is received, the load balancer 3b stores the received packet into a memory without performing an operation of registering new access control information to the access correspondence table 9b and an operation of returning an error message which is issued when the access control information is not registered yet.

In an actual packet communication, a case occurs such that a packet having a destination IP address in the transition mode arrives at the load balancer 3b after switching of the communication route performed in a second step of which will be described hereinafter.

With respect to the received packet having the destination IP address in the normal operation mode, after performing the translation of the destination IP address explained in FIGS. 4A and 4B, the load balancer 3b transfers the packet to the internal network 4.

In the case where the received packet is a connection settlement request packet for starting the Web access, in preparation for transfer of a packet for a Web access received after that and returning of an access response from the server, a new access control information entry is registered in the access correspondence table. When a packet including, as a destination IP address, an IP address which is not designated in any of the transition mode and the normal operation mode is received, the load balancer discards the received packet and returns an error message to the source of the packet.

In order to store a correspondence relation between the destination IP address of a packet to be received and the transfer operation mode, that is, the transition mode and the normal operation mode, the load balancers 3a and 3b have transfer processing mode tables 7a and 7b shown in FIGS. 7A and 7B, respectively.

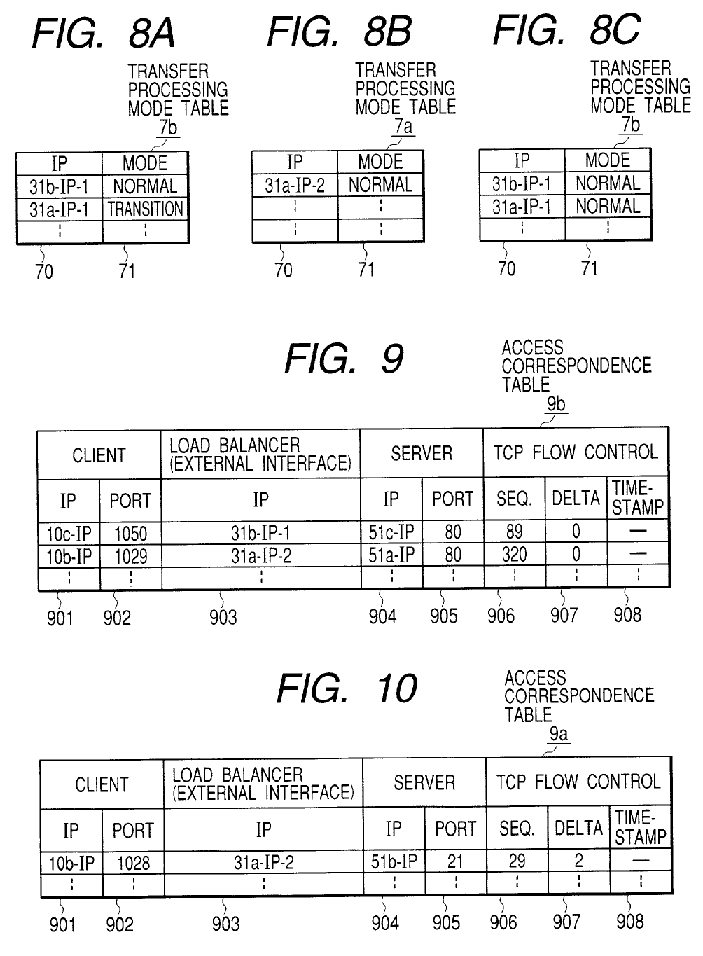

The transfer process mode tables 7a and 7b shown in FIGS. 7A and 7B show the contents before the notification of transition of the IP address “31a-IP-1”. When the notification of transition of the IP address “31a-IP-1” is received from the control server 5c, the contents of the transfer process mode table 7b of the load balancer 3b change as shown in FIG. 8A.

As described above, in the transfer process mode tables 7a and 7b of the load balancers, in correspondence with a destination IP address 70 of a packet to be transferred, a process mode 71 indicative of the normal operation mode or transition mode is stored.

After the first step is finished, the IP address “31a-IP-1” as an object to be shifted remains registered as a normal operation mode in the transfer process mode table 7a of the load balancer 3a. A received packet having the IP address “31a-IP-1” as a destination IP address is transferred to the target server 5a via the load balancer 3a as before.

In the second step, in response to the control message from the control server 5c (control function 52), the route of relaying the packet having the destination IP address “31a-IP-1” is switched from the load balancer 3a to the load balancer 3b. The switching of the relay route is achieved by setting the IP address “31a-IP-1” to the external interface 31b of the load balancer 3b and canceling the setting of the IP address “31a-IP-1” to the external interface 31a of the load balancer 3a.

By changing the assignment of the IP address to the external interface, the access route, that is, the connection router function between the Internet 2 and the server 5a belonging to the IP address “31a-IP-1”, is switched from the load balancer 3a to the load balancer 3b. For the switching, a method such as Proxy ARP, OSPF, or server route change described in Literature 3 can be applied. The VRRP (“Virtual Router Redundancy Protocol”, RFC2338 of Internet Engineering Task Force) may be also used.

After completion of the second step, the packet having the destination IP address “31a-IP-1” transmitted from the client 1a to the Internet 2 is received by the load balancer 3b in place of the load balancer 3a. Since the IP address “31a-IP-1” has been set in the transition mode in the first step, the received packets are successively stored in the memory in the load balancer 3b.

In a third step, under the control of the control server 5c (control function 52), all of access control information entries whose load balancer IP address 903 is “31a-IP-1” are moved from the access correspondence table 9a of the load balancer 3a to the access correspondence table 9b of the load balancer 3b.

Specifically, an entry whose IP address 903 is “31a-IP-1” in the access correspondence table 9a is copied to the access correspondence table 9b in the load balancer 3b, and an entry which becomes unnecessary is deleted from the access correspondence table 9a.

FIGS. 9 and 10 show the contents of the access correspondence tables 9b and 9a after execution of the third step, respectively.

In a fourth step, a notification of end of the switching of the access route regarding the IP address “31a-IP-1” is transmitted from the control server 5c (control function 52) to the load balancers 3a and 3b.

In response to the notification of end, the load balancer 3a deletes a mode information entry regarding the IP address “31a-IP-1” from the transfer process mode table 7a as shown in FIG. 8B. On the other hand, in response to the notification of end, the load balancer 3b rewrites the transfer processing mode of the IP address “31a-IP-1” in the transfer process mode table 7b from the transition mode to the normal operation mode and, after that, performs transfer processing of the packets having the destination IP address “31a-IP-1” stored in the memory, in accordance with the access correspondence table 9b updated in the third step.

Specifically, the load balancer 3b refers to the access correspondence table 9b by using the source address (800, 801) and the destination address (802, 803) of the packet read out from the memory as a retrieval key, and translates the destination IP address of the packet to an IP address “51a-IP” shown in the server address 904 of the access correspondence table 9b. The address-translated packet is transmitted to the server 5a via the network 4.

By adopting the above procedure, the route of the communication packets between the client and the server can be changed, as necessary, from a first route passing through a load balancer to a second route passing through another load balancer, and the communication load can be dynamically distributed or changed among a plurality of load balancers.

2. Second Embodiment of the Invention

In Literature 1, the basics of the address translation are explained. In the present invention, another address translation method modified from the basic address translation can be also used.

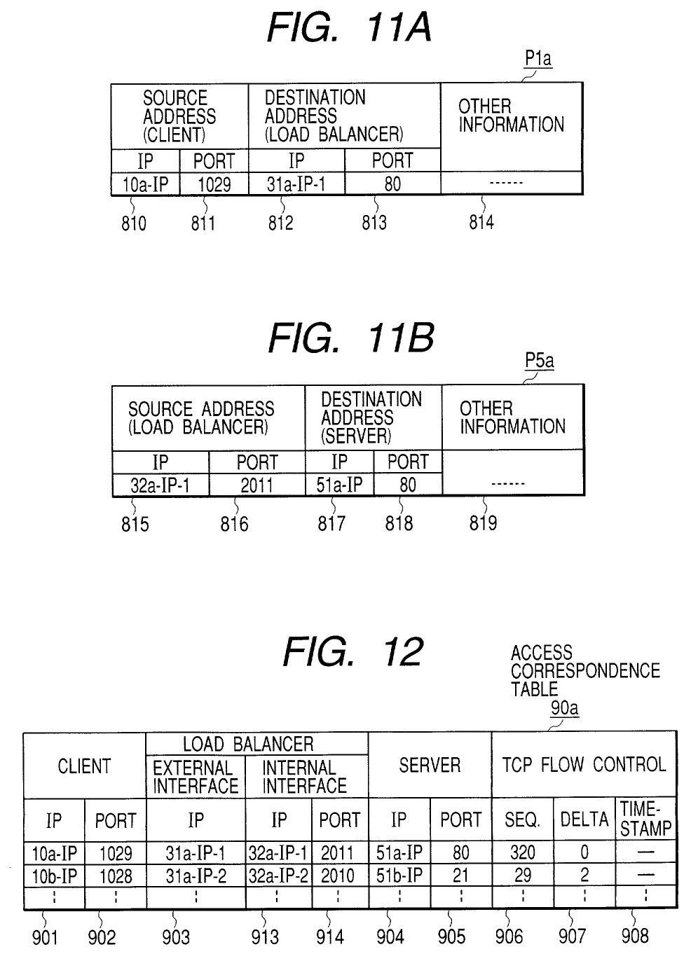

Referring to FIGS. 11A and 11B and FIG. 12, an address translating method of a second embodiment will be described hereinbelow.

FIG. 11A shows the format of a communication packet transmitted between the client 1a and the load balancer 3a, and FIG. 11B shows the format of a communication packet between the load balancer 3a and a server 51. As obviously understood from the comparison between FIGS. 11A and 11B, in the embodiment, not only the destination IP address 812 (817) of a received packet but also an IP address 810 (815) and a port number 811 (816) of the source are also changed by a load balancer.

In order to perform such address translation, in the embodiment, the load balancer 3a uses an access correspondence table 90a shown in FIG. 12. The access correspondence table 90a includes not only information items 901 to 908 of the access correspondence table 9a of the first embodiment shown in FIG. 5 but also an internal IP address 913 and a port number 914 assigned to an internal interface 32a of the load balancer 3a.

In the embodiment, the source address 815 and 816 of the packet P5a sent from the load balancer 3a (or 3b) to a server is translated to the address of the load balancer 3a (or 3b). Consequently, for the server 5a (5b or 5c), it is seen that the access requester is not the clients 1a to 1c but is the load balancer 3a (or 3b).

The IP address of each server therefore does not have to belong to an external IP address assigned to the external interface 31a (or 31b) of the load balancer unlike the first embodiment. The IP address of each server belongs to the address (913, 914) assigned to the internal interface of the load balancer, and the address of the internal interface is associated with the external interface address of any of the load balancers. Therefore, when the address translation of the embodiment is employed, the connection relation between the load balancer and the server can be flexibly changed.

In the case of applying the address translation of the embodiment to the load balancers 3a and 3b shown in FIG. 3, access control information is set in an access correspondence table in a form that the IP address of the internal interface 32a (32b) belongs to the IP address of the external interface 31a (31b). Therefore, in the third step described in the first embodiment, the access control information is moved in the form including the IP address of the external interface and the IP address of the internal interface belonging to the IP address of the external interface. The first, second, and fourth steps are performed in a manner similar to the first embodiment.

3. Third Embodiment of the Invention

In the foregoing embodiments, the procedure of balancing and changing the communication load among load balancers has been described. In a third embodiment of the invention, a method of implementing failover among load balancers will be described. In failover, in a manner similar to the distribution of a communication load, an access route is moved from a load balancer, for example, 3a to another load balancer, for example, 3b.

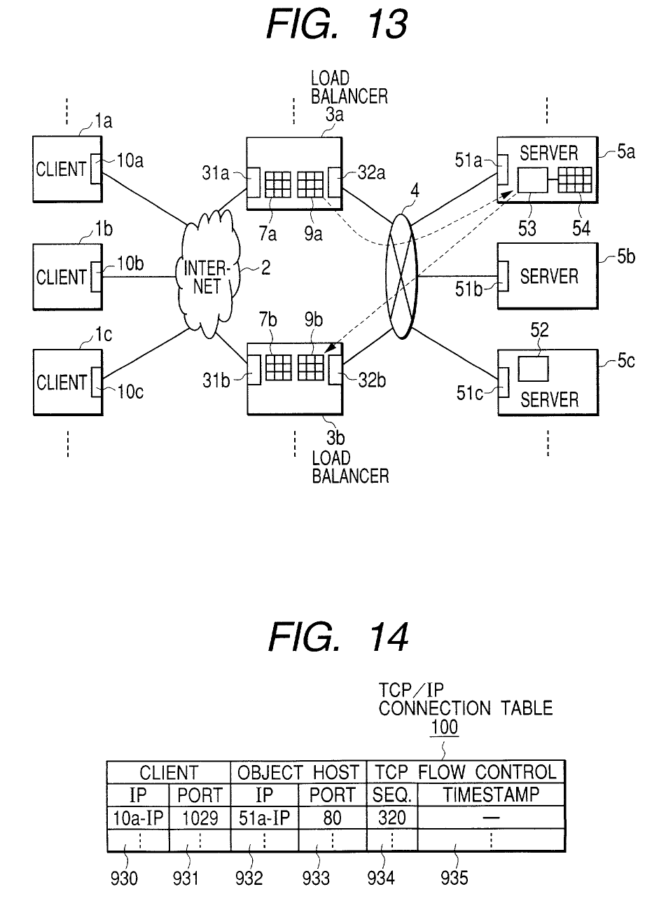

In many cases, when a serious failure to a degree that failover is required occurs, it is impossible to read out the contents of the access correspondence table from a load balancer in which the failure occurs. Consequently, in the embodiment, as shown in FIG. 13, when the load balancers 3a and 3b are in a normal operating state, a part or all of access control information entries registered in the access correspondence tables 9a and 9b are periodically transmitted to the server 5a, 5b, or 5c to be accessed.

Each server processes the access control information entries received from the load balancer by a copy keeping function 53 and stores the resultant as a copy 54 of the access correspondence table. Although the copy keeping function 53 is shown only in the server 5a in FIG. 13, all of servers which can become objects to be accessed have the copy keeping function 53.

Failover is carried out basically in the procedure comprising of the first to fourth steps for shifting the access route described in the first embodiment. Since it is not guaranteed that transfer of access control information between the access correspondence tables performed in the third step can be perfectly executed, in the third step of failover, a copy of the access correspondence table stored in the server is set as the access correspondence table of the load balancer to be the destination of the access route switching.

For example, the control procedure performed in the case where a failure which requires failover occurs in the load balancer 3a and, as a result, the access route is shifted from the load balancer 3a to the load balancer 3b will be described.

It is now assumed that the contents of the access correspondence table 9a used by the load balancer 3a just before a failure occurs is kept in the server 5a as a copy thereof.

In the first step, in response to a notification from the control server 5c (control function 52), the load balancer 3b adds an entry indicating that the IP address “31a-IP-1” is a transition mode to the transfer process mode table 7b.

In the second step, the setting of the IP address “31a-IP-1” to the external interface is changed from the load balancer 3a to the load balancer 3b in response to a control message from the control server 5c (control function 52), thereby switching the communication route of the packet having the destination IP address “31a-IP-1” from a route passing through the load balancer 3a to another route passing through the load balancer 3b.

In the third step, the control server 5c (control function 52) instructs the server 5a to be accessed by the load balancer 3a to transmit an access control information entry whose IP address 903 is “31a-IP-1” read out from the copy 54 of the access correspondence table 9a from the server 5a to the load balancer 3b, so that the access control information entry is registered in the access correspondence table 9b of the load balancer 3b.

In the fourth step, an access route switching end notification is transmitted from the control server 5c (control function 52) to the load balancers 3a, 3b.

In response to the notification of end, the load balancer 3a deletes, if it is operable, a mode information entry having the IP address “31a-IP-1” from the transfer process mode table 7a. The load balancer 3b rewrites the process mode of the IP address “31a-IP-1” in the transfer process mode table 7b from the transition mode to the normal process mode.

The load balancer 3b accordingly reads out stored packets having the IP address “31a-IP-l” from the memory, translates the address in accordance with the access correspondence table 9b, and transmits the resultant to the network 4. As described above, switching of the access route for failover is executed by the control function 52 of the control server 5c in a manner similar to the first embodiment.

The contents of the access correspondence table to be stored when the load balancer operates normally as a copy 54 in a server accessed through a load balancer will be described.

In a system configuration in which the load balancer employs the address translation of the first embodiment in which only the destination IP address of a packet received from a client is rewritten, the client address 901 and 902, the server port number 905, and TCP flow controls 906, 907, and 908 shown in FIG. 5 are stored as the copy 54.

In this case, each server belong to the specific external IP address 903 in any of the load balancers, and the relation between the external IP address 903 and the server IP address 904 is a known value in the control function 52, so that it is unnecessary to store those information items as the copy 54.

On the other hand, in the system configuration employing the address translation of the second embodiment in which the source IP address and the destination IP address of a packet received from a client are rewritten, all the items except for the server IP address 904 in the access correspondence table 90a shown in FIG. 12 are stored in a server to be accessed.

The invention is not limited to the foregoing embodiments and their modifications but can be also realized as the following various modifications and other modifications. The technique of any of the plurality of embodiments and their modifications can be also combined with any of the following modifications.

(1) Modification 1

In a network system to which the address translation of the first embodiment is applied and which uses a protocol like, for example, the HTTP (HyperText Transfer Protocol) that does not need the TCP flow control information 906, 907, and 908 shown in the access correspondence tables 9a and 9b, the operating system of the server 5a and/or the adapter 51a is provided with a TCP/IP connection table 100 in which connections of TCP/IP are listed as shown in FIG. 14. It is therefore unnecessary to store the contents of the access correspondence table 9a as a copy 54 for the purpose of realizing failover.

In this case, at the time of executing failover, in the third step, the contents of the connection table 100 are copied into the access correspondence table 9b, the IP address to which the server 5a belongs is set as the load balancer IP address 903 and zero is set as the value of delta 907 in the access correspondence table 9a.

(2) Modification 2

At the time of failover, after executing the third step described in the third embodiment, that is, after setting the contents of the copy 54 of the access correspondence table or the TCP/IP connection table 100 shown in FIG. 14 into the access correspondence table 9b, the second step may be carried out. In this case, it is unnecessary to set the load balancers 3a and 3b into the transition mode.

(3) Modification 3

The invention is also applicable to apparatuses other than the load balancer, such as an NAT (Network Address Translator) and a network adapter. In recent years, because of development of a network such as InfiniBand, an interface device such as an adapter is not limited to a conventional form that it is housed in a server but can be externally attached to a communication apparatus and/or can be shared by a plurality of communication apparatuses as reported by “InfiniBand Architecture Specification Volume 1”, Infiniband Trade Association.

For example, Japanese Unexamined Patent Publication No. 10-69471 discloses a shared network adapter for connecting with a parallel computer or cluster. FIGS. 3 and 4 of the publication show tables for address translation performed between an external network address (connection identifier) and an internal buffer. The tables correspond to the access correspondence table 9 (9a, 9b) in the present invention.

Therefore, for example, in the case where the network 4 shown in FIGS. 3 and 13 of the invention is made correspond to the InfiniBand or a network in the publication and the load balancers 3a and 3b are made correspond to a shared adapter, it is understood that the invention is applicable to distribution and/or failover of the communication load among shared adapters.

(4) Modification 4

The invention is also applicable to an adapter for processing a communication protocol. In recent years, an adapter for performing the TCP/IP process has been developed as reported by “Integrating the LAN, WAN & SAN for Optimized Network Performance”, e-Commerce Infrastructure Technologies Conference and Tradeshow, Monterey, USA, February 2001, Lucent Technologies. This type of adapter is provided with the TCP/IP connection table shown in FIG. 14.

Since the invention is also applied to the transfer of the TCP/IP connection table among adapters, the invention is applicable to distribution and/or failover of a communication load among a plurality of adapters.

(5) Modification 5

The invention is also applicable to protocols other than TCP/IP. In the invention, the communication protocol applied between a client (1a to 1fc) and a load balancer (3a, 3b) does not have to be the same as that used between a load balancer (3a, 3b) and a server (5a to 5c). Different type of communication protocols may be applied according to network zones.

For example, “fast socket” is known as a technique for realizing high-speed communication by mapping calling of a communication related function of an application to a high-speed communication function of a network such as the InfiniBand. Examples of a conventional technique related to the fast socket are known, for example, by Japanese Unexamined Patent Publication No. 11-328134, the method of University of California, Berkeley (by S. H. Rodrigues, T. E. Anderson, and D. E. Culler, “High-Performance Local Area Communication with Fast Socket”, Proceedings of the USENIX '97, 1997, pp. 257-274) and the method by Shah et al. (H. V. Shah, C. Pu, and R. S. Madukkarumukumana, “High Performance Sockets and RPC over Virtual Interface (VI) Architecture”, Proceedings of CANPC '99, 1999).

In the fast socket, a unique protocol different from the IP is used. Therefore, for example, in a network configuration in which a communication is performed between the load balancer (3a, 3b) and the client (1a to 1c) by the IP protocol and a communication is performed between the load balancer (3a, 3b) and the server (5a to 5c) by the fast socket, a table similar to the access correspondence tables (9a, 9b, and 90a) is used in order to translate the IP address of the client to an address used for the fast socket. In this table, in place of the addresses (904,905) on the server side in the access correspondence table, an address used for the fast socket is set.

The invention is also applicable to the communication load distribution and/or failover in the network configuration to which such fast socket is applied.

(6) Modification 6

The apparatus of the invention may be a communication apparatus such as an NAT apparatus or gateway apparatus having the function of performing conversion between a communication protocol on the Internet 2 and a communication protocol on the network 4, for example, fast socket communication and having no load balancing function.

(7) Modification 7

In the embodiments shown in FIGS. 3 and 13, the server 5c is the control server having the control function 52. The control function 52 may be provided for the other server 5a or 5b, load balancer 3a or 3b, or other device not shown in the drawings.

(8) Modification 8

The copy keeping function 53 and the copy 54 of the access correspondence table described in the third embodiment may be provided for a device other than the server in a manner similar to Modification 7.

(9) Modification 9

To the invention, a communication load distribution algorithm other than the communication load distribution algorithm described in Literature 3 can be applied.

(10) Modification 10

The access correspondence table is not limited to the configurations shown in FIGS. 5, 6, and 12 but may include other columns (information items) in accordance with the functions of the load balancers 3a and 3b. The TCP/IP connection table shown in FIG. 14 may also include other columns (information items) in accordance with the functions of the operating system and adapter.

(11) Modification 11

Also in the first embodiment, in a manner similar to the third embodiment, the copy 54 of the access correspondence table 9a may be stored and, when the communication load is distributed among the load balancers, the access control information read out from the copy 54 may be set in the access correspondence table 9b, in place of the access correspondence table 9a in the third step.

(12) Modification 12

At the time of performing failover among the load balancers, if the access control information can be read out from the access correspondence table 9a, in place of the copy 53, the access control information read out from the access correspondence table 9a may be set into the access correspondence table 9b.

A program for realizing the functions of the invention can be distributed in a form such that it is stored, the program alone or combined with another program, into a program storing medium such as a disk memory device. A program for carrying out the function of the invention may be installed adding to a communication control program being already used or replacing with a part of an existing communication control program.

According to the invention, dynamic distribution of communication loads among the load balancers can be realized, and the invention has the effect on improvement in scalability, improvement in communication packet transfer efficiency by automatic tuning, and reduction in costs. According to the failover among load balancers of the invention can improve the availability of the whole site and system in the network.

According to the invention, without changing the destination address of the connection on the client side, the communication route between a client and a server can be dynamically switched from a route passing through a load balancer to a route passing through another load balancer.

In the invention, except for the time in the operation for balancing the communication load and the failover operation, communications among the load balancers are unnecessary. Consequently, a dedicated connection line is unnecessary among load balancers. Thus, a number of load balancers can be mounted in parallel, and the scalability of the system can be improved.

According to the invention, since failover can be carried out without interrupting server access, the invention is adapted to a site of electronic transaction or the like where interruption of an access and loss of data are problems.

What is claimed is:

1. An information processing system to be accessed through a network, comprising:
a plurality of information processors for executing information processing in response to a received packet;
a plurality of address translators capable of operating in parallel with each other and being disposed between an external network and an internal network to which said information processors are connected, ach of said address translators operating to translate a destination address of a packet received from said external network to an address indicative of one of said information processors to be accessed, and to transfer the address-translated packet to said internal network;
means for holding an access correspondence table corresponding to each of said address translators, said access correspondence table having a plurality of control information entries each defining the relation among a source address, an address assigned to an external interface connected to said external network, and a destination address indicative of an information processor to be accessed; and
a controller for switching an access route to a specific information processor from a first route passing through a first address translator to a second route passing through a second address translator,
said controller having means for instructing said second address translator to store received packets for accessing said specific information processor into a memory, instructing said first and second address translators to change address information, which is set to designate packets to be received, in such a manner that the packets for accessing said specific information processor are received by the second address translator in place of said first address translator, shifting a control information entry whose destination address indicates said specific information processor from an access correspondence table corresponding to said first address translator to an access correspondence table corresponding to the second address translator, and notifying said second address translator of end of the route switching, and wherein
said second address translator starts, in response to said notification of end, an operation of translating the destination address of packets stored in said memory in accordance with said access correspondence table corresponding to the second address translator to transfer the packet to said internal network.

2. The information processing system according to claim 1, wherein said controller composes a part of one of said plurality of information processors.

3. The information processing system according to claim 1, wherein each of control information entries registered in each of said access correspondence tables includes an internal address assigned to an internal interface connected to said internal network in correspondence with an information processor to be accessed, and
each of said address translators translates a destination address and a source address of a packet received from said external network into a destination address and an internal address indicated by one of control information entries in an access correspondence table corresponding to the address translator.

4. The information processing system according to claim 1, wherein each of said address translators has an access correspondence table corresponding thereto,
a copy of each of control information entries in each of said access correspondence tables is stored in one of said information processors corresponding to a destination address defined in the control information entry, and
said controller performs said shifting of said control information for switching the access route by using the copy.

5. An information processing system to be accessed through a network, comprising:
a plurality of servers for executing information processing according to a received packet;
a plurality of load balancers capable of operating in parallel with each other and being disposed between an external network and an internal network to which said servers are connected, each of said load balancers translating at least a destination address of a packet received from said external network to an address indicative of one of said servers to be accessed, and transferring the address-translated packet to said internal network;
means for holding an access correspondence table corresponding to each of said load balancers, said access correspondence table having a plurality of control information entries each defining the relation among an address indicative of a packet transmission source, an address assigned to an external interface connected to said external network, and a destination address indicative of a server to be accessed; and
a controller for switching an access route to a specific server from a first route passing through a first load balancer to a second route passing through a second load balancer,
said controller having means for instructing said second load balancer to store received packets for accessing said specific server into a memory, instructing said first and second address translators to change address information, which is set to designate packets to be received, in such a manner that packets for accessing said specific server are received by the second load balancer in place of said first load balancer, shifting the control information entry whose destination address indicates said specific server from an access correspondence table to be referred to by said first load balancer to an access correspondence table to be referred to by said second load balancer, and notifying said second load balancer of end of the route switching, and wherein
said second load balancer starts, in response to said notification of end, an operation of translating an address of a packet stored in said memory in accordance with said access correspondence table corresponding to the second load balancer to transfer the packet to said internal network.

6. A packet processing method in an address translator for translating an address of a packet received from an external network and transferring the packet to an internal network to which a plurality of information processors are connected, comprising the steps of:
when a control packet for starting an access to one of said information processors is received from said external network, generating a control information entry indicative of a corresponding relation among an address of a packet transmission source, an address assigned to an external interface which has received said control packet, and a destination address indicative of one of said information processors to be accessed, and registering the control information entry into an access correspondence table;
when a message indicating that an access route with respect to an address assigned to said external interface is being switched is received from a controller connected to said internal network, registering said address in a memory as an address in a transition mode;
when a user packet is received from said external network, referring to said access correspondence table and, if a control information entry corresponding to the received packet is registered, translating a destination address of said received packet in accordance with the control information entry and transferring the address-translated packet to said internal network; and
when the control information entry corresponding to said received packet is not registered in said access correspondence table, if the destination address of the received packet is registered as the address in said transition mode, storing the received packet into a memory and, if the destination address of the received packet is not registered as the address in said transition mode, discarding the received packet.

7. The packet processing method according to claim 6, further comprising the step of:
saving the contents of each control information entry registered in said access correspondence table into an information processor indicated by a destination address of the entry at a predetermined timing.

8. A method of shifting a packet transfer load from a first address translator to a second address translator, the address translators capable operating in parallel with each other and being disposed between an external network and an internal network to which a plurality of information processors are connected, each of said address translators translating a destination address of a packet received from said external network into a destination address indicated by an information entry corresponding to the received packet with reference to a control table having a plurality of control information entries each defining relations of an address of a packet transmission source, an address assigned to an external interface connected to said external network, and a destination address indicative of an information processor to be accessed, and transferring the packet to said internal network,
the method comprising the steps of:
operating said second address translator in an operation mode for storing received packets to be transferred to a specific information processor in the translator without transferring the received packets to said internal network;
changing address information set in said first and second address translators for designating packets to be received, so that packets for accessing said specific information processor are received by said second address translator in place of said first address translator;
shifting a control information entry whose destination address indicates said specific information processor from the control table referred to by said first address translator to the control table referred to by said second address translator; and
operating said second address translator in an operation mode for translating the address of each of said stored packets and a packet received thereafter which should be transferred to said specific information processor in accordance with said control table and transferring the address-translated packet to the internal network.

9. A method of shifting a packet transfer load according to claim 8, wherein each of said address translators has said control table to be referred to, and the method further comprises the steps of:
storing in each of said information processors a copy of information entries each including an address of the information processor as a destination address; and
shifting the control information entry held by said specific information processor to a control table to be referred to by said second address translator.

10. A program executed by a computer to control a packet transfer load in a plurality of address translators disposed between an external network and an internal network to which a plurality of information processors are connected, each of said address translators translating a destination address of a packet received from said external network to a destination address indicated by an information entry corresponding to the received packet with reference to a control table having a plurality of information entries each defining the relations among an address of a packet transmission source, an address assigned to an external interface connected to said external network, and a destination address indicative of one of said information processors to be accessed, and transferring the packet to said internal network, said program making the computer perform:
a step of specifying an information processor for which switching of an access route from a first route passing through a first address translator to a second route passing through a second address translator is required;
a step of instructing said second address translator to shift into an operation mode for temporarily storing a received packet to be transferred to said specified information processor in the translator without transferring the received packet to said internal network;
a step of instructing said first and second address translators to change address information, which is set to designate packets to be received, so that packets to be transferred to said specific information processor are received by said second address translator in place of said first address translator;
a step of shifting the control information entry whose destination address indicates said specified information processor from a control table referred to by said first address translator to a control table referred to by said second address translator; and
a step of instructing said second address translator to operate in an operation mode for translating the address of each of said stored packets and a packet received thereafter which should be transferred to said specified information processor, with reference to said control table and transferring the packet to said internal network.
